(19) United States
(12) Patent Application Publication
(10) Pub. No.: US 2025/0088781 A1
(43) Pub. Date: Mar. 13, 2025

(54) CLOSED SOUND RECEIVER WITH SOUND-PERMEABLE BOUNDARY SURFACE

(71) Applicant: Fraunhofer-Gesellschaft zur Förderung der angewandten Forschung e.V., München (DE)

(72) Inventors: Martin Damian TROCHOWSKI, Ilmenau (DE); Moritz BRANDES, Ilmenau (DE)

(73) Assignee: Fraunhofer-Gesellschaft zur Förderung der angewandten Forschung e.V., München (DE)

(21) Appl. No.: 18/957,861

(22) Filed: Nov. 24, 2024

Related U.S. Application Data
(63) Continuation of application No. PCT/EP2023/063647, filed on May 22, 2023.

(30) Foreign Application Priority Data
May 24, 2022 (DE) 102022205148.3

(51) Int. Cl. H04R 1/08; H04R 1/02; H04R 1/28

(52) U.S. Cl. CPC H04R 1/086; H04R 1/028; H04R 1/2876; H04R 2410/07; H04R 2499/13

(57) ABSTRACT

A sound receiving arrangement for being mounted in an outer shell of an object, wherein the outer shell has a recess, having: a housing which is arranged in the recess and forms a hollow space; an acoustically permeable boundary surface which closes the hollow space; a sound receiver arranged within the housing so that a medium is provided between the sound receiver and the acoustically permeable boundary surface.

### CROSS-REFERENCE TO RELATED APPLICATIONS

This application is a continuation of copending International Application No. PCT/EP2023/063647, filed May 22, 2023, which is incorporated herein by reference in its entirety, and additionally claims priority from German Application No. 102022205148.3, filed May 24, 2022, which is also incorporated herein by reference in its entirety.

### TECHNICAL FIELD

Embodiments of the present invention relate to a closed sound receiver with a sound-permeable boundary surface (sound receiving arrangement) for being mounted in an outer shell of an object. Further embodiments relate to a closed acoustic sensor with a sound-permeable boundary surface for receiving sound for being installed in the outer shell of an object or building outdoors. Fields of application of embodiments are objects such as, for example, mobile or movable objects, in particular vehicles, aircraft and boats, but also buildings. In this respect, further embodiments relate to an outer wall or a wall of a building and to a mobile or movable object comprising a corresponding sound receiving device.

### BACKGROUND OF THE INVENTION

Receiving sound outdoors poses particular requirements to corresponding sensor systems. These must be robust and weather-resistant. In addition, it is of utmost importance for such a sensor to receive as little wind noise or travel wind noise as possible. Thus, a good aerodynamic profile or measures for reducing wind noise play a key role. Sound reception must remain ensured.

If such a sensor is to be installed in objects located outdoors or moving outdoors (e.g. a free-standing unit or a vehicle), or else in a house front, what aggravated the situation is the question of how it can be integrated in a reasonable manner.

A conventional procedure is installing a microphone in a housing. The microphone is then connected to the outside air via a sound channel (or generally an air path). Thus, an acoustic membrane can be introduced in front of or into this acoustic channel in order to protect the microphone from moisture and to prevent dust or the like from penetrating into the channel. This concept is referred to as an “open sensor”. The housing is installed or mounted in the outer casing of the object.

For example, DE 10 2019 220 204 A1, which discloses a structure for a microphone, is to be mentioned as known technology. Such a structure causes problems in the case of strong wind or in the case of induced relative wind at relatively high speeds, for example when a vehicle is moving. Wind noise is induced at the sound opening, at edges and at irregularities. Starting from a certain wind or object speed, the ratio between useful signal and interference noise is shifted to the interference noise to such an extent that it is impossible to use the sensor despite the use of software for suppressing interference noise (known technology). A further problem is the robustness of the sensors. (An acoustic membrane is significantly easier to damage when compared to other, stronger/stiffer materials). A third problem is the complexity of the described teaching since an acoustic membrane is clamped adaptively via corresponding electronics/mechanics.

Since there is no barrier between the microphone and the outside air (apart from an optional acoustic membrane), a comparatively good sound reception can be achieved at a standstill and in the case of no wind.

An alternative solution is to position the microphones or the entire sensors behind a fixed casing where no flows or strong pressure fluctuations are to be expected. In addition, there are hardly any problems concerning the robustness and weather resistance. In a project in which microphones were installed in a vehicle for external noise perception, the following positions were tested, among others:

Vehicle interior (strong interference by vehicle passengers and music from entertainment system), in the external mirrors (strong attenuation by mirror and mirror housing), in the trunk (strong attenuation by car body), under the engine hood (strong interference by engine and other components). All these solutions result in less wind noise due to the separating material, but also impair the useful signals significantly since, although the materials do not allow flow pass-through, they also very strongly attenuate sound waves. In addition, the noise from the vehicle itself is received more strongly. Therefore, there is need for an improved approach.

The object underlying the present invention is to improve sound measurements, by means of a sound measuring arrangement attached to the outer skin, with respect to receiving quality, in particular at higher movement speeds, and robustness.

### SUMMARY

An embodiment may have an object having a sound receiving arrangement for being mounted within an outer shell of the object, wherein the outer shell of the object has a recess, the sound receiving arrangement having: a housing which is arranged in the recess of the outer shell of the object and forms a hollow space; an acoustically permeable boundary surface which closes the hollow space; a sound receiver arranged within the housing so that a medium is provided between the sound receiver and the acoustically permeable boundary surface; wherein a solid body material or partial solid body material associated with the outer shell is provided between the acoustically permeable boundary surface and the housing; so that the acoustically permeable boundary surface of the sound receiving arrangement forms a continuation of the outer shell of the object.

Another embodiment may have an object having a sound receiving arrangement for being mounted behind an outer shell of the object, the sound receiving arrangement having: a housing which is arranged in a recess behind the outer shell of the object and forms a hollow space; an acoustically permeable boundary surface which is part of the outer shell of the object and closes the hollow space; a sound receiver arranged within the housing so that a medium in the form of a solid body material or partial solid body material is provided between the sound receiver and the acoustically permeable boundary surface; wherein the solid body material or partial solid body material connected to the acoustically permeable boundary surface is provided between the acoustically permeable boundary surface and the housing.

Another embodiment may have an outer wall as an object or wall as an object having a sound receiving device as mentioned above.

Another embodiment may have a mobile or movable object, in particular vehicle, aircraft or boat, having a sound receiving device as mentioned above.

Embodiments of the present invention provide a sound receiving arrangement in (e.g. in the sense of within) an outer shell of an object, such as, for example, a building, an outer wall of a building or a wall of a building or also an outer shell of a mobile object such as, for example, a vehicle. The outer shell has a recess, e.g. in the sense of a depression or notch (e.g. hole into which the sensor is integrated with its outer skin and the housing). The sound receiving arrangement comprises:
a housing
an acoustically permeable boundary surface
a sound receiver.

The housing is arranged or embedded in the recess, e.g. so that a closed shape results. The housing may have a hollow shape. The acoustically permeable boundary surface closes this hollow space. The sound receiver (or microphone) is arranged within the housing or the hollow space so that a medium is provided between the sound receiver and the acoustically permeable boundary surface.

Examples of recesses are a depression in a house front or a hole/a notch in a vehicle body outer skin/sheet.

It is to be noted that the outer shell forms a type of surface layer of the object and has a recess open towards the surface. The acoustically permeable boundary surface delimits the housing with the hollow space towards the environment.

According to embodiments, the medium comprises, for example, air or also a material or another gas. According to embodiments, the acoustically permeable boundary surface forms a continuation of the outer shell of the object. It is to be noted that the acoustically permeable boundary surface constitutes a separate material/object which terminates so as to be flush with the surrounding outer surface.

Embodiments of the present invention are based on the finding that, by means of a corresponding recess, a microphone encapsulated in a housing or, generally, (encapsulated) sound receiving means can be arranged in the recess. The closed shape of the housing prevents moisture or dust or other solid objects from penetrating into the sensor. The recess can also entail an advantage with respect to robustness should the boundary surface have a hole as a result of damage, since moisture and dust cannot immediately touch the microphone because of the distance and moisture can “trickle off”. This has an advantageous effect on the robustness and longevity of the sensor. In this respect, embodiments of the present invention combine the advantage of a closed system (reduced wind noise, no penetration of moisture or dust) with that of an open system (direct sound path between the outside and microphone and thus improved transmission of the airborne sound).

Due to the fact that a continuation of the outer shell is formed by the acoustically permeable boundary surface, a planar surface of the boundary surface can be created together with the surrounding boundary of the object, or the outer shell of the object, such as, for example, a house front. Consequently, hardly any wind noise is induced at this surface in the case of flows or wind when compared to other solutions, in particular because the flows or wind flow past the surface and does not experience any unevenness.

This applies in particular when the flow is parallel to the surface. This is the case in particular in the case of mobile objects at higher speeds, for example vehicles. In our opinion, this property is the greatest and most decisive advantage.

According to further embodiments, the acoustically permeable boundary surface and/or the outer shell can be coated or provided with a varnish. Consequently, a further advantage is that the acoustically permeable boundary surface could be provided with a varnish and thus would no longer be visible in certain objects, for example in the case of vehicles, if the same varnish is used which is also used for the boundary.

According to embodiments, the sound receiving arrangement in which the medium or at least a part of the medium is formed by a sound-permeable volume can comprise the acoustically permeable boundary surface. As a result of this variation, the acoustically permeable boundary surface becomes significantly more robust.

According to embodiments, an acoustic insulator is provided between an inner side of the housing and the sound receiver, which comprises, for example, sand, bitumen, foam, polymeric chambers and/or a further material. This has the advantage that noise from the object itself, such as, for example, from the engine compartment of a vehicle, is also received by the sound receiver to a reduced extent.

In order to provide a coherent connection to the backfilling of the outer shell or of the outer shell itself, for example in order to select the planar surface or the planar surface provided with a varnish, according to embodiments, the housing can be connected to the outer shell or to a backfilling of the outer shell or of the object via a rear of the housing.

It is to be pointed out here that, according to embodiments, the cavity in the housing or even the recess of the housing or even the housing itself has a funnel shape, for example. The funnel shape as one of the possible (inner) shapes is, from an acoustic point of view, advantageous as such, wherein further shapes would also be possible. The sound receiver can be arranged, for example, in the last third of the funnel. In some implementations, the funnel shape has the technical advantage that a type of acoustic filtering of the sound from secondary noises is already carried out by this.

Examples of the acoustically permeable boundary surface are cited below. It can, for example, comprise one of the following materials:
rigid foam plate
filmed rigid foam plate
PUR or PIR
plastic plate
HDPE
highly resistant plastic film
PMMA, PTFE or PET
sheet metal.

It is to be pointed out here that in order to optimize the transition between the sound-permeable boundary surface and the outer shell of the object, sealing elements such as, for example, a rubber lip may also be provided. According to further embodiments, the acoustically permeable boundary surface may be reinforced or stiffened. It may have stiffened struts, for example. Alternatively, a strut for supporting the acoustically permeable boundary surface with respect to the housing would also be conceivable. In order to, according to further embodiments, combine the advantages of the rubberized or flexible transition to the outer skin and the mounting of the acoustically permeable boundary surface, according to embodiments, it can be mounted by means of a sprung suspension, e.g. relative to the housing.

As already explained above, according to embodiments, the outer shell and the acoustically permeable boundary surface form a planar surface with planar transitions. In the case of a curved outer surface, it would be of advantage for the outer surface to be also curved in a corresponding profiling. Thus, according to embodiments, the acoustically permeable boundary surface may have a curved shape. According to embodiments, the recess and thus also the housing and also the plan view of the acoustically permeable boundary surface is round or oval, for example. This allows stress-free mounting at the bearing points. Theoretically, other shapes (angular, etc.) would also be conceivable.

Further embodiments relate to an outer wall as an object or a wall as an object comprising a sound receiving device.

According to a further embodiment, a mobile or movable object, in particular vehicle, aircraft or boat, is equipped with a sound receiving device.

### BRIEF DESCRIPTION OF THE DRAWINGS

Embodiments of the present invention are explained below referring to the appended drawings, in which:

FIG. 1 shows a schematic representation of a basic implementation of a sound receiving arrangement;

FIG. 2 shows a schematic representation of an expanded embodiment of a sound receiving arrangement; and

FIG. 3 shows a further schematic representation of a sound receiving arrangement according to extended embodiments for discussing optional features.

### DETAILED DESCRIPTION OF THE INVENTION

Before embodiments of the present invention are explained below referring to the appended drawings, it is to be pointed out that the same elements and structures are provided with the same reference numerals so that the description thereof is mutually applicable or interchangeable.

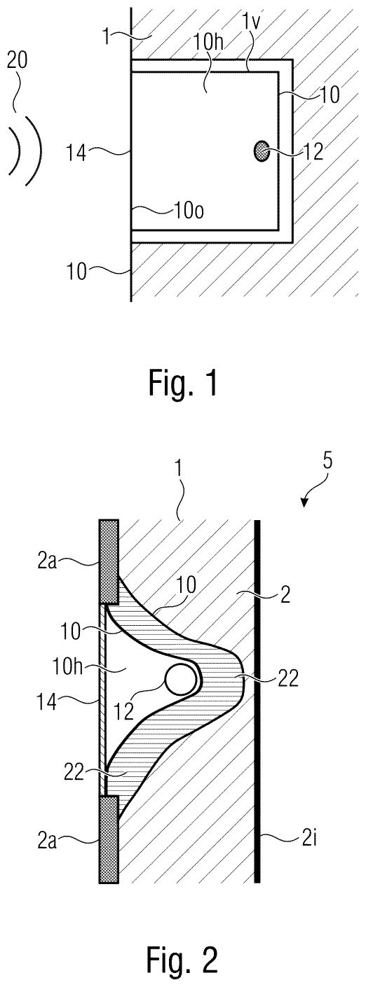

FIG. 1 shows an object 1 having an object volume and an object surface 1o. The object can be, for example, a house front or also the outer skin of a mobile object such as, for example, an automobile. The surface 1o is thus the uppermost terminating layer of the object 1. Starting from the surface 1o, a recess 1v extends into the object body of the object 1. A device for receiving sound with the housing 10 is arranged in the recess 1V. The device for receiving sound comprises a housing 10 with a sound receiver 12 arranged in the housing 10, such as, for example, a microphone. The microphone is arranged, for example, at the rear wall of the housing 10, i.e. in the cavity of the housing 10. Opposite the rear, the housing 10 comprises an opening 10O which is arranged at the front of the housing 10, i.e. at the surface which substantially continues the outer surface 10O. From a geometric point of view, this means that the housing opening 10O is approximately a continuation of the outer skin 1O of the object 1, while the rear of the housing 10 projects into the volume of the object. The sound 20 impinges on the outer skin 1O and the opening 10O via the front. This sound can then be received via the microphone 12. According to embodiments, the microphone 12 is arranged deep in the housing 10, e.g. in the rear third as viewed from the front 10o.

The opening 10O is closed by an acoustically permeable boundary surface 14 so that the hollow space 10H in which the microphone 12 is located is encapsulated. As a result of the position of the microphone 12 in the hollow space 10H or the rear part of the hollow space, a distance results between the microphone 12 and the acoustically permeable boundary surface 14, which is filled with a medium, such as, for example, air or another gas. The acoustically permeable boundary surface 14 is defined, e.g., as a planar body which is configured to transmit sound. The acoustic boundary layer may have (as a lower limit) a thickness of at least 0.1 mm, at least 0.5 mm, at least 1 mm, at least 2 mm or even at least 3 mm, for example. Upper limits for the thickness are, for example, 10 mm or 5 mm or 3 mm or 2 mm or 1.5 mm. Of course, filling with a type of solid body or partial solid body, such as, for example, a foam (with pores, i.e., open-pore foam) would also be conceivable. In the case of a solid material in the hollow space or as a “base” of the acoustic boundary surface, a so-called structure-borne sound receiver would be reasonable. Partially, according to embodiments, this can also mean that the region between the acoustically permeable boundary surface and the sound receiver does not comprise regions filled with the solid body in the sense of hollow spaces.

It is also to be noted that the solid body material or partial solid body material can be connected to the acoustically permeable boundary surface (as a separate element). For example, the acoustically permeable boundary surface can be formed by a sheet metal, a varnished sheet metal, a varnish carrier layer or a surface element. In other words, the recess can be formed by a surface element (varnished sheet metal in analogy to the outer skin) or the outer skin itself, which forms the acoustically permeable boundary surface.

A further embodiment provides a sound receiving arrangement for being mounted within or behind an outer shell of an object, comprising:
a housing which is arranged in a recess behind the outer shell and forms a hollow space;
an acoustically permeable boundary surface which is part of the outer shell and closes the hollow space;
a sound receiver arranged within the housing so that a medium is provided between the sound receiver and the acoustically permeable boundary surface.

A solid body material or partial solid body material associated with the outer shell is provided between the acoustically permeable boundary surface and the housing.

The structure having already been explained above, the mode of operation will be discussed below.

The outside of the housing 10, i.e. the region in which the sound 20 impinges on the sound-permeable membrane 14, is encapsulated by the sound-permeable boundary surface or generally the boundary surface 14. The sound-permeable properties induce the sound pressure on the inside of the housing 10, i.e. in the hollow space 10H, and can be received by the microphone 12. The encapsulation by the permeable boundary surface 14 allows the outside air not coming into contact with the microphone 12 and thus moisture permeability and weathering resistance being provided.

According to embodiments, the sound-permeable boundary surface 14 may continue the surface 10O accordingly or even continue the same in a planar manner. This prevents co-noises from forming at the transitions between the housing 10 and the object 1. For this purpose, according to embodiments, sealing elements (not illustrated) may also be provided. With regard to the sound-permeable membrane 14, it is to be noted that, according to embodiments, it consists of a material which is solid, robust, moisture-impermeable, weather-resistant, but nevertheless sufficiently acoustically permeable. For this reason, the surface is referred to as an acoustically permeable boundary surface. With regard to the media present on the outside and inside, it is to be noted that the acoustically permeable boundary surface can come into contact with air, for example, both on the outside and on the inside, wherein, according to further embodiments, other media, such as, for example, a gas, an inert gas, but also fluid, can also be used.

With regard to the microphone, it is to be noted that it converts the sound 20 arriving within the housing 10 into an electrical signal. According to embodiments, further electronics may also be provided in addition to the actual sensor. Typically, the electrical signal or the electrical signal preprocessed by means of the electronics is guided out of the housing 10 via a cable. Wireless transmission, e.g., by radio, would also be conceivable.

An extended embodiment is shown below referring to FIG. 2.

FIG. 2 shows a sound receiving arrangement 5 with a housing 10, an inner housing 10 or a hollow space 10H of the microphone 12 arranged in the housing, wherein the hollow space 62 is encapsulated by the acoustically permeable membrane 14. The housing 10 is embedded in an intermediate material 2 of the object 1, wherein an inner boundary 2i and an outer boundary 2a are provided in the object 1.

A recess/hole matching the shape is located in the boundary 2 and 2a of a mobile or immobile object 1 or a house front which is in contact with the outside air and into which the acoustic sensor is to be installed. The housing 10 is inserted in this recess. According to embodiments, the recess is—usually, but not necessarily—circular. The housing 10 is usually/according to embodiments, but not necessarily, inserted into this recess from the inside. According to embodiments, the housing 10 is usually, but not necessarily, mounted on the boundary 2a and 2i of the object or on the house front from the inside.

According to an advantageous, but not necessary, embodiment, the acoustically permeable boundary surface 14 forms a planar surface together with the surrounding boundary 2a of the object 1 or the house front. The surface 14 is formed from an acoustically permeable material and can be curved or otherwise shaped according to embodiments, for example according to the boundary 2a of the object 1 or house front.

Optionally, the housing 10 contains an acoustic insulation 22 towards the inside of the object 1 or the building 10 in order to suppress noise from the object 1 or the building itself. This acoustic insulation 22 can be implemented in various ways and is therefore in principle not limited to a specific implementation. One instance is a filling of sand, bitumen, foam or other materials. A further instance is a several consecutive chambers of air, which can also be filled with foam or sand or similar material. A further type of implementation is layers made of different materials, which have different resonance frequencies, with or without additional air cushions between the layers.

According to embodiments, the inner side of the housing 10, in which the sound receiver 12 is placed, can assume different shapes. An acoustically beneficial shape, which allows optimized sound reception, e.g., a funnel, is of advantage.

It is to be pointed out here that, according to embodiments, rigid foam plates of PUR/PIR with or without additional filming of the surface, for example the brand name Kapa, are suitable as materials for the acoustically permeable boundary surface 14. Various solid (i.e., non-flexible) plastics, i.e., a thin plastic plate, such as HDPE, would also be suitable. Various highly resistant plastic films made of materials such as PMMA, PTFE or PET, for example, would also be conceivable. A thin sheet metal would also be conceivable. The invention is not limited to certain material groups. The materials mentioned represent examples or various instances. All materials which meet the above-mentioned requirements also form part of this invention. The thickness of the boundary surface is critical in any case. It represents a compromise between robustness or mechanical stability and acoustic permeability.

Concerning the sound receiver: it converts acoustic sound into an electrical voltage or an electrical current. All transducer principles are possible here. In embodiments, part of the acoustic sensor may be further electronics installed in the housing (H). An electronic interface may be part of the sensor. This interface usually, but not necessarily, leads to the interior of the object. Direct guidance of cables from the housing into the interior of the object or the house would also be conceivable. Transmitting the acoustic signals via radio would also be conceivable.

With regard to the arrangement of the acoustically permeable boundary surface 14 and the surrounding boundaries 2a of the object or the house front, it is to be noted that they advantageously form a planar surface, i.e. are provided to be flush. Thus, hardly any wind noise is induced at these surfaces in the case of flows or wind when compared to other solutions, since the flows or the wind flow past the surface and do not experience any unevenness.

With regard to the signal quality according to this teaching, it is to be noted that, according to an embodiment, a compromise is provided between the closed and open system. When compared to the open system, in the case of no wind, the transmission of the airborne sound (in the case of the materials which we have in mind) is worse (e.g., a porous rigid foam plate is still a solid material, pores nevertheless allow better sound transmission when compared to other solid materials but poorer transmission than a pure air channel or acoustic membrane), but the transmission in the case of wind, for example, is improved instead.

In another instance/according to a further embodiment, the acoustically permeable boundary surface 14 is supported from behind (i.e. from the side facing the object or on the side on which the sound receiver is located) by struts of other materials, for example sheet metal or steel. This increases the stiffness and the mechanical strength of the boundary surface. The support can, for example, be implemented to be grid-shaped. The support could allow a boundary surface which is thinner when compared to a case without a support and which transmits the sound better without threatening the mechanical strength.

Thus, these supports can extend in parallel to the acoustic boundary surface 14 as reinforcing structures in the form of bars or a grid arrangement. Alternatively, support of the surface 14 relative to the rear of the housing 10 by perpendicular or transversely extending supports would also be conceivable.

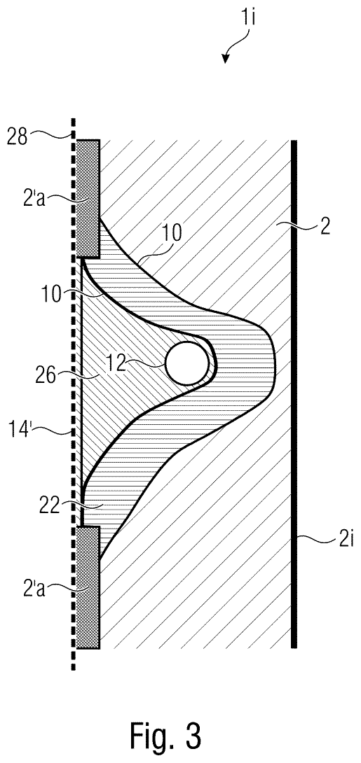

Referring to FIG. 3, a further embodiment is explained, wherein it is already to be pointed out here that the basic structure of variation 1′ from FIG. 3 corresponds to the variation 1 from FIG. 2, but in addition further optional features are also present.

In a further embodiment, the medium 26 between the sound-permeable boundary surface 14′ and the sound receiver 12 is made of a solid material which can conduct structure-borne sound sufficiently well. In this instance, the sound receiver 12 corresponds, for example, to a structure-borne sound receiver or acceleration sensor which is attached to this intermediate material. In a further embodiment, this intermediate material can be the same as the material of the sound-permeable boundary surface; the sound-permeable boundary surface is replaced by a sound-permeable volume.

In this respect, in this embodiment, the hollow space 26 is filled by a structure which also improves the mechanical robustness of the acoustically permeable boundary surface 14′.

Further embodiments are an adaptation of all the previously mentioned embodiments, in that the acoustically permeable boundary surface 14′ is additionally varnished.

This means that the acoustically permeable boundary surface 14′ or the outer skin 2a′ is varnished by a varnish 28. In this case, usually, but not necessarily, the same varnish is used which is also used for the surrounding boundary if this surrounding boundary is varnished.

Further instances/embodiments result from an adaptation of all the previously mentioned embodiments, in which the housing (but not the sound-permeable boundary surface, if present) is spring-mounted in order to achieve improved acoustic decoupling with respect to natural noises of the object or the house if this decoupling should be of advantage for the application.

Further instances/embodiments result from an adaptation of all the previously mentioned embodiments, in which an acoustically insulating layer is additionally placed between the acoustically permeable boundary surface and the boundary or the housing 10 or both, e.g. in the form of a rubber lip, in order to achieve improved acoustic decoupling with respect to the boundary of the object or the house front if this insulation should be of advantage in the application.

An advantageous variation (according to an embodiment) will be explained below starting from the basic features and optional features explained above. The structure substantially corresponds to that discussed in FIG. 1, wherein the following additions/variations are added:
microphone as sound receiver
filmed rigid foam plate with additional varnish as acoustically permeable boundary surface
circular acoustically permeable boundary surface
acoustically permeable boundary surface forms a planar, smooth surface together with the boundary
funnel-shaped housing interior
microphone in the center of the funnel
no rubber lip or spring suspension
sand as acoustic insulation

Applications for embodiments of the present invention are:
topic “the hearing car”
   acoustic external perception/environment detection
   detecting rolling noise of the tires (road surface recognition)
   detecting natural noises of the vehicle (self-diagnosis, condition monitoring)
   etc.
detection of noise in the environment
acoustic monitoring of roads
theft protection of free-standing objects (recording of speech and noise in the case of an attempted theft)
detection of environmental noise with simultaneous detection of noise of the object itself

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An object comprising a sound receiving arrangement for being mounted within an outer shell of the object, wherein the outer shell of the object comprises a recess, the sound receiving arrangement comprising:
a housing which is arranged in the recess of the outer shell of the object and forms a hollow space;
an acoustically permeable boundary surface which closes the hollow space;
a sound receiver arranged within the housing so that a medium is provided between the sound receiver and the acoustically permeable boundary surface;
wherein a solid body material or partial solid body material associated with the outer shell is provided between the acoustically permeable boundary surface and the housing; so that the acoustically permeable boundary surface of the sound receiving arrangement forms a continuation of the outer shell of the object.

2. The sound receiving arrangement according to claim 1, wherein the medium or at least a part of the medium is formed by a sound-permeable volume comprising the acoustically permeable boundary surface.

3. The sound receiving arrangement according to claim 1, wherein an acoustic insulator is provided between an inner side of the housing and the sound receiver, in particular an acoustic insulator comprising sand, bitumen, foam, polymeric chambers.

4. The sound receiving arrangement according to claim 1, wherein the inner side of the housing is acoustically insulated.

5. The sound receiving arrangement according to claim 1, wherein the housing is connected to the outer shell or a backfilling of the outer shell or the object via a rear of the housing.

6. The sound receiving arrangement according to claim 1, wherein the recess and/or the hollow space of the housing comprise a funnel shape.

7. The sound receiving arrangement according to claim 1, wherein the acoustically permeable boundary surface comprises one of the following materials:
filmed rigid foam plate
rigid foam plate
PUR or PIR
plastic plate
HDPE
highly resistant plastic film
PMMA, PTFE or PET
sheet metal.

8. The sound receiving arrangement according to claim 1, wherein the acoustically permeable boundary surface and/or the outer shell comprise a varnish.

9. The sound receiving arrangement according to claim 1, also comprising at least one rubber lip provided at the transition between the acoustically permeable boundary surface and the outer shell.

10. The sound receiving arrangement according to claim 1, wherein the acoustically permeable boundary surface is connected to the housing by a spring suspension and/or mounting.

11. The sound receiving arrangement according to claim 1, wherein the solid body material or partial solid body material comprises or forms the acoustically permeable boundary surface; or
wherein the solid body material or partial solid body material is connected to the acoustically permeable boundary surface or wherein the solid body material or partial solid body material is connected to the acoustically permeable boundary surface and wherein the acoustically permeable boundary surface is formed by a sheet metal, a varnished sheet metal, a varnish carrier layer or a surface element.

12. The sound receiving arrangement according to claim 1, wherein the acoustically permeable boundary surface is curved and/or projects out of the plane or projects into the plane; and/or
wherein the acoustically permeable boundary surface and/or the housing and/or the recess are circular.

13. The sound receiving arrangement according to claim 1, wherein the outer shell and the acoustically permeable boundary surface form a plane or curved planes or surface or curved surface.

14. An object comprising a sound receiving arrangement for being mounted behind an outer shell of the object, the sound receiving arrangement comprising:
a housing which is arranged in a recess behind the outer shell of the object and forms a hollow space;
an acoustically permeable boundary surface which is part of the outer shell of the object and closes the hollow space;
a sound receiver arranged within the housing so that a medium in the form of a solid body material or partial solid body material is provided between the sound receiver and the acoustically permeable boundary surface;
wherein the solid body material or partial solid body material connected to the acoustically permeable boundary surface is provided between the acoustically permeable boundary surface and the housing.

15. An outer wall as an object or wall as an object comprising a sound receiving device according to claim 1.

16. A mobile or movable object, in particular vehicle, aircraft or boat, comprising a sound receiving device according to claim 1.

17. An outer wall as an object or wall as an object comprising a sound receiving device according to claim 14.

18. A mobile or movable object, in particular vehicle, aircraft or boat, comprising a sound receiving device according to claim 14.
